(19) United States
(12) Patent Application Publication
(10) Pub. No.: US 2006/0098570 A1
(43) Pub. Date: May 11, 2006

(54) OFDMA system and method

(76) Inventor: Zion Hadad, Rishon Lezion (IL)

Correspondence Address: ZION HADAD, 48 HAALMOGIM STREET, RISHON LEZION, IL

(21) Appl. No.: 11/305,148

(22) Filed: Dec. 19, 2005

(30) Foreign Application Priority Data
Jun. 19, 2003 (IL) 156540
Jun. 20, 2004 (WO) PCT/IL04/00552

(51) Int. Cl. H04J 11/00

(52) U.S. Cl. 370/210

(57) ABSTRACT

A cellular wireless system using a single frequency OFDMA channel. Base stations include means for synchronization in frequency and time for control purposes. The synchronization means include same Frame numbers and slot index and same reference clock. In a cellular wireless system using a single frequency OFDMA channel, wherein base stations include means for synchronization in frequency and time for control purposes, a method for organizing data and pilots into sub-channels comprising pilots allocations among BSs. The method may further include taking the variable pilots and performing the allocation while shifting through time.

### FIELD OF THE INVENTION

This invention relates to a system and method for synchronization and channel estimation in same-frequency wireless cellular networks.

### CROSS-REFERENCE TO RELATED APPLICATIONS

The present application is related to, and claims priority from, the patent application No. 156540 filed on Jun. 19, 2003 in Israel and entitled “OFDMA system and method”, and application PCT/IL 2004/000552 filed 20 Jun. 2004.

### BACKGROUND OF THE INVENTION

The invention addresses the problem of interference at a Subscriber Unit (SU) resulting from transmissions from other Base Stations (BS), in networks using Orthogonal Frequency Division Multiple Access (OFDMA).

When multiple BS transmitters use the same frequency channel for downlink and/or uplink transmission, some of the SUs may suffer from severe interference.

This happens because these SUs receive downlink transmissions from more than one BS, at comparable power levels. FIG. 1 depicts this situation, where a SU 11 located in one of the overlap regions 12, 13 may receive downlink transmissions from more than one BS 14, 15 (or 14, 16 respectively) at comparable power levels.

The interference problem is more difficult to solve in OFDMA systems, wherein adjacent base stations use the whole channel. In older FDMA systems (see FIG. 2), the channel is separated into disjoint sub-channels, four in this example. These include the channels C1, C2, C3, C4 in the frequency domain, that may be allocated separately, and wherein in each allocation only part of the bandwidth is used. Filtering, together with different channel allocation for each BS, can be used to reduce interference.

It is an objective of the present invention to overcome various problems in cellular wireless networks.

### SUMMARY OF THE INVENTION

According to the present invention, there is provided a system and method for wireless OFDMA.

In OFDMA systems (for example, as described in IEEE 802.16a or in EN-301-958), the channel is separated into sub-channels, for example the channels C1, C2, C3, C4 as illustrated in FIG. 3, wherein each sub-channel is spread over the entire bandwidth. This scheme achieves improved frequency diversity and channel usage (no need for frequency separation between sub-channels).

For example, in a system according to IEEE 802.16 for mobile applications, the basic synchronization sequence is based on a predefined sequence of data that modulates a subset of the sub-carriers, see FIG. 4. Sub-carriers belonging in this subset are called pilots and are divided in two groups.

One group is of fixed location pilots and the other is of variable location pilots. There is a variable location pilot every twelve sub-carriers, and it is changing position each OFDMA symbol with a cycle repeating every four OFDMA symbols. FIG. 4 shows the IEEE 802.16a OFDMA basic synchronization sequence.

The pilots in OFDMA are used for synchronization as well as for channel estimation, so it is essential to prevent or reduce interference on these sub-carriers, to achieve a high performance downlink.

A PMP sector contains one Base Station (BS) and multiple Subscriber Units (SU). The network topology shall contain multiple BSs, operating within the same frequency band. The transmission from the BS to the SU is referred as Downlink, and the transmission from the SU to the BS is referred as Uplink. By using Orthogonal Frequency Division Multiple Access (OFDMA) technique with large FFT, the present invention provides means for:

A. Reducing interference that SUs may suffer due to reception of transmission from more than one BS.

B. Efficient usage of the radio frequency channel for frequency reuse factor of 1, by segmenting the channel into sub-channels and usage of centralize\distributed decision mechanisms to allocate sub-channels to different BSs.

C. Coordination between BSs for sub-channel allocations and data transmission for efficient Hand-Over (HO) mechanisms.

D. Static sub-channel allocations, or dynamic sub-channel allocations according to specific usage scenario, or for load balancing.

E. Usage of Forward Automatic Power Control (FAPC) to increase in adaptive way the SNR of each sub-channel

The present invention relates to the OFDMA PHY layer and cellular point-to-multipoint (PMP) networks. It is suitable both for a fixed and mobile environment. It provides a method of using multiple BS transmitters operating in partially overlapping areas, using a single frequency channel for downlink transmissions for all the BSs/sectors.

In one embodiment of the invention, it covers OFDMA systems in which each OFDMA symbol's duration is more than 50 microseconds, and may depend on the channel bandwidth. This may directly affect the number of FFT points in the OFDMA system.

The interference level can be greatly reduced by

1. Transmitting a modified synchronization sequence from each BS, to enable unambiguous synchronization of each SU in each cell. The BS are assumed to share a common frequency/timing reference, typically derived from GPS, but other techniques may also be used.

2. Reducing the level of collisions between BS transmissions, by either

a. Synchronizing BS transmissions through their management interface

b. Keeping the traffic load level at each BS low enough, such that the resulting collisions can be tolerated or corrected at higher layers in the protocol stack

c. Assigning of different sub-channels to different BSs in order to achieve sub-channel separation (carriers separation) between BSs.

3. Using downstream adaptive transmission and FAPC

In a OFDMA system, the BS will include means for sending information to a specific SU or a group of SUs on a dedicated sub-channel(s) in the downstream.

These means provide a facility for boosting the power of the carriers of particular sub-channels of the BS, while reducing the power of other sub-channels.

This property will increase the total link-budget of the system, allowing to communicate with SU that are distant or have a very low reception Signal to Noise Ratio (SNR).

In a OFDMA system, in the downlink direction, each sub-channel may be transmitted using a different modulation scheme and coding rate.

The BS may choose not to transmit on all available sub-channels. The BS may use a subset of the available sub-channels for downstream data transmission, for example:

transmitting on half of the sub-channels, while power boosting them by 3 dB. This will add power gain to the system, since the power shall be used to transmit on part of the channel and not for the whole channel.

4. Synchronizing between BSs.

According to yet another aspect of the invention, unambiguous synchronization of each SU in each cell can be achieved by a novel system wherein all BSs are synchronized in frequency and time, having the same Frame numbers and slot index, and the same reference clock like GPS or other external synchronization mechanism, which creates a macro-synchronized system for control purposes.

Furthermore, diversity channel improvement is achieved in a system and method using concurrent communications with more than one base station, to improve the quality of communications and/or to increase the instantaneous bandwidth with a specific user, as is deemed desirable at a given moment.

These interference reduction means are further detailed below, and with reference to the accompanying drawings.

Further objects, advantages and other features of the present invention will become obvious to those skilled in the art upon reading the disclosure set forth hereinafter.

### BRIEF DESCRIPTION OF THE DRAWINGS

FIG. 1 illustrates interference from adjacent base stations in a wireless cellular system

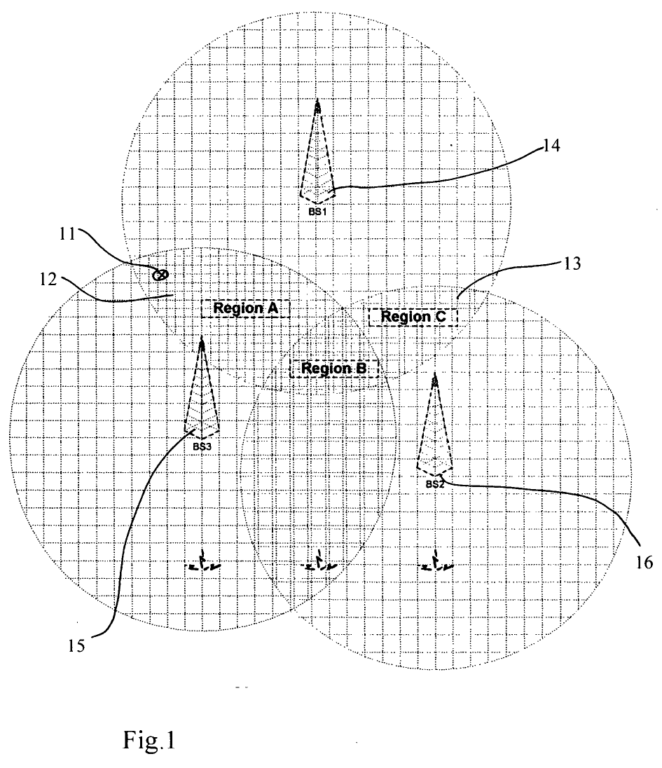

FIG. 2 illustrates channels definition in FDMA (prior art)

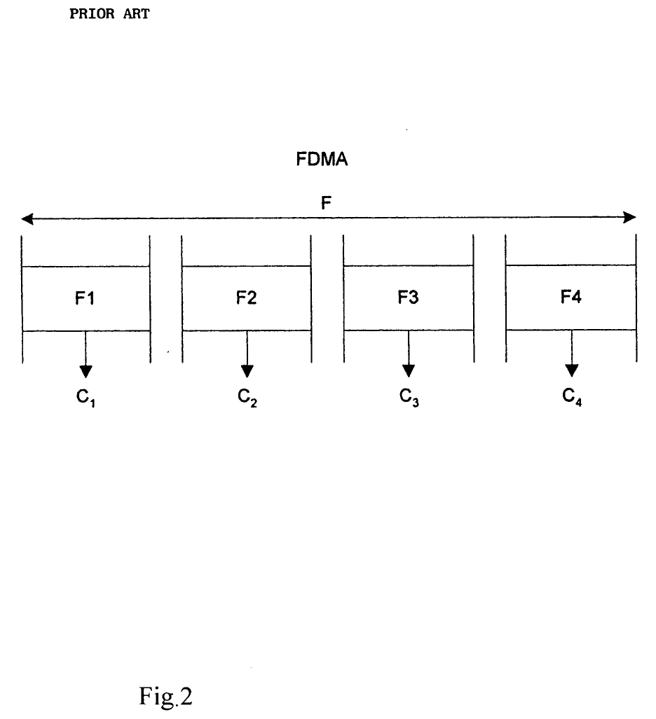

FIG. 3 illustrates channels definition in OFDMA (prior art)

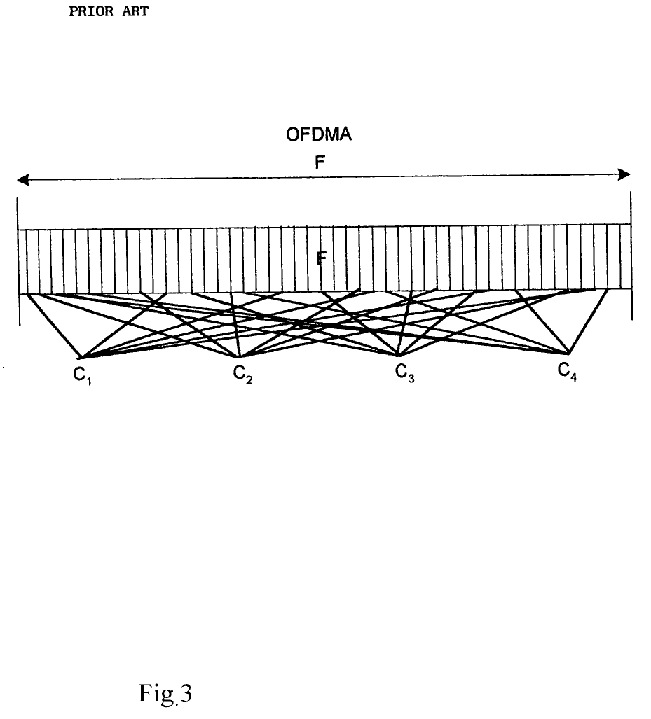

FIG. 4 details the basic synchronization sequence in OFDMA (prior art)

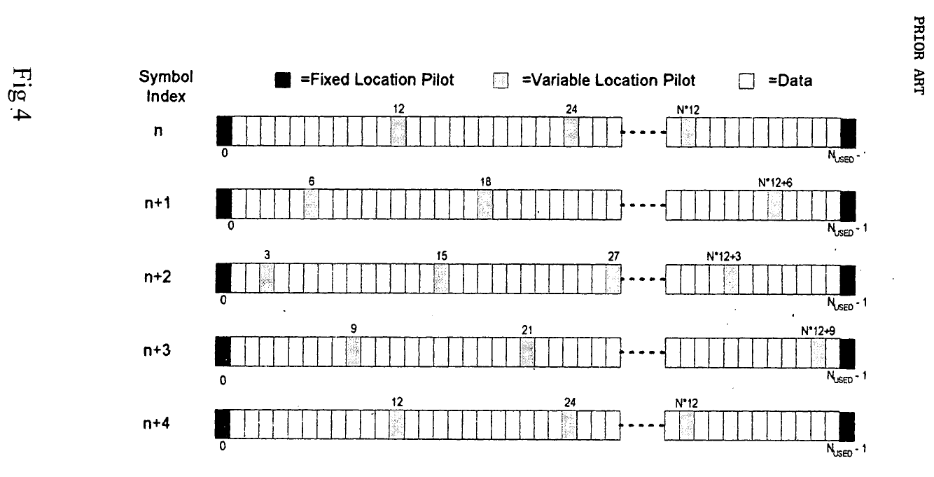

FIG. 5 illustrates a synchronization method using subcarriers allocation

FIG. 6 illustrates sub-carrier sharing among adjacent base stations

### DETAILED DESCRIPTION OF THE PREFERRED EMBODIMENTS

A preferred embodiment of the present invention will now be described by way of example and with reference to the accompanying drawings.

According to the invention, unambiguous synchronization of each SU in each cell can be achieved by a novel system wherein all BSs are synchronized in frequency and time, having the same Frame numbers and slot index, and the same reference clock like GPS or other external synchronization mechanism, which creates a macro-synchronized system for control purposes.

Such an OFDMA system may use the property, that the sub-channels are shared between different BSs.

Furthermore, a large FFT (long OFDM symbols, with duration of at least 4 time than the cell radius electromagnetic propagation time) can be used, to create a large enough Guard Interval (GI), which enables ability of proper reception of information from several BSs in parallel while using same RF receiver and same FFT for all BSs.

Unambiguous synchronization of each SU in each cell can be achieved by a method including transmitting a modified synchronization sequence from each BS.

The BS share a common frequency/timing reference, derived for example from GPS, although other techniques may also be used.

A method for interference reduction will now be detailed, that may be advantageously used to improve performance in IEEE 802.16 in mobile applications, for example.

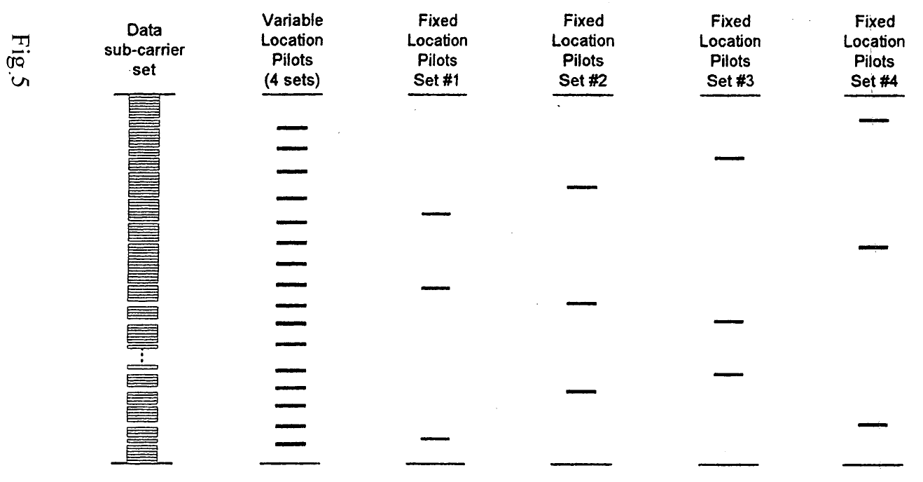

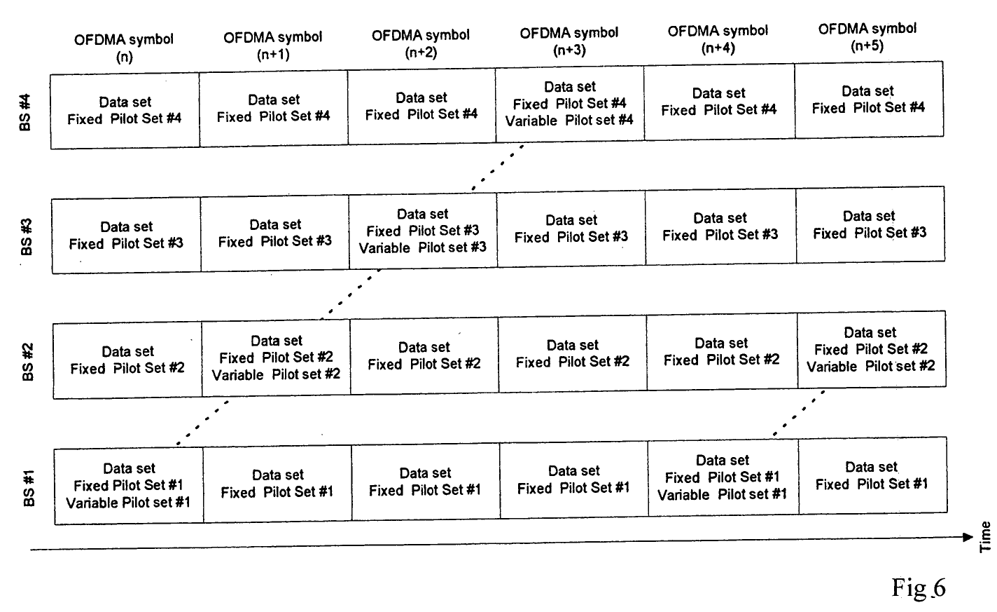

See FIGS. 5 and 6, for an embodiment relating to four base stations. The pilots may be shared as detailed above referring to OFDMA.

In a preferred embodiment, the pilots retain their position as defined in the IEEE 802.16a specification.

Method for Interference Reduction

Following is an embodiment of a method for interference reduction, that may be used in the IEEE 802.16 or other technologies.

1. Synchronize the BS symbol index to a common reference. For example, a global reference may be used, such as GPS. When using GPS, each BS assumes that symbol indexed 0 has occurred in a predefined time in the past (e.g. 1-1-1990 at 00:00.00). The same OFDMA symbol length must be used in all BS. In another embodiment, a local reference may be used, common to just the base stations in a specific network.

2. Assign to each BS an index in the range 0 to N.

3. Allocating a subset of the synchronization sequence to each BS. Each BS will use its index to determine which subset to transmit. The transmission is synchronized with the other base stations as all the base stations are synchronized to a common reference.

These subsets are predefined and known to all BS and SU.

Each BS may broadcast the network topology to all the SUs, such information contains details about the neighbors cells/sectors, what other frequencies are in use in neighbor cells, or which resources (like sub-channels) are free to be used (for example in Hand Over procedures).

4. The subsets of the synchronization sequence may be disjoint.

5. There may also be a sharing in the time dimension where several BS transmit a synchronization sequence with overlap in the frequency domain, but never do it on the same OFDMA symbol.

6. At the SU allow synchronization on each of the subsets. This is possible as long as
Npilots_in_subset/(Subcarrier_Spacing_{—}NFFT)>Tchannel_delay

End of method.

7. Reducing the level of collisions between BS transmissions can be achieved by:

a. Synchronizing BS transmissions through their management interface

b. Keeping the traffic load level at each BS low enough, such that the resulting collisions can be tolerated or corrected at higher layers in the protocol stack

c. Assigning of different sub-channels to different BSs in order to achieve frequency orthogonality between BSs.

Using the procedures outlined above, each SU can synchronize with each BS without interference from other BS, or at a reduced level of interference. There may still be interference in the data transmissions itself.

This interference can be tolerated even without taking any special precautions, provided that the forward APC feature of OFDMA is utilized, the downlink permutations are exploited and that the traffic load at each BS is kept low enough. In this case, those occurrences in which interference has caused transmission errors will be taken care of by higher layers in the protocol stack without severely degrading the performance of the network.

In order to further enhance the performance of the network, the transmission of the BS can be coordinated. As the BS share a common backbone infrastructure, it is possible for them to communicate with each other and coordinate their transmissions. This coordination can be done with respect to the OFDMA frame number that is common to all BS. The coordination can be done in the time domain (e.g. BS#1 uses the first half of the OFDMA frame while BS#2 uses the third quarter).

The coordination can be performed through the BS management interface in either distributed or centralized fashion, and does not affect the air-interface.

The property of sharing sub-channels between different BSs and coordination between the BSs can be used to achieve the following:

a. Dynamic sub-channel assignment to a BS according to the specific load in the BS.

In a cellular system, the number of active users per cell, and the traffic profile per call may change through time, especially in mobile systems. The BSs shall perform resource allocation in a coordinated fashion, to be able to provide more resources (i.e. sub-channels) to BSs with high activity on the expense of BSs with low activity.

b. Interference avoidance by allocating sub-channels to BSs with low co-interference properties.

c. For mobile SUs that are migrating between two BSs, same data can be transmitted by the two BSs to the SU, to enable smooth migration from one BS to the other (Hand Over) without data loss. The SU can combine the data digitally using various methods, for example:

1) Two BSs transmits the same data to SU using same sub-channel.

The channel combines the data, which will be non-coherent under each BS transmission and can be considered as multipath. This can give good reception diversity, while enabling the SU to demodulate the combined data in a coherent fashion.

2) Two BSs can transmit the same data to SU using different sub-channels.

The SU demodulates the signals coherently and combines them using a Maximal Ratio Combining method, for example.

According to yet another aspect of the invention, the interference level can be further reduced by using downstream adaptive transmission and FAPC.

In a OFDMA system, the BS shall have the ability of sending information to a specific SU or a group of SUs on a dedicated sub-channel(s) in the downstream.

In this case, the BS can have the ability of boosting power of the carriers of particular sub-channels while reducing power of other sub-channels.

This property will increase the total link-budget of the system, allowing working with SU that are distant or have very low reception Signal to Noise Ratio (SNR).

In a OFDMA system, in the downlink direction, each sub-channel may be transmitted using a different modulation scheme and coding rate.

The BS may choose not to transmit on all available sub-channels. The BS may use a subset of the available sub-channels for downstream data transmission, for example:

transmitting on half of the sub-channels, while power boosting them by 3 dB.

This will add power gain to the system, since the power shall be used to transmit on part of the channel and not for the whole channel.

The BS keeps track, for each SU, or generally for the downstream channel, of the sub-carriers having a low SNR and of those having a high SNR value. Based on this information, the BS can do one of the following:

a. Not modulating information on carriers that has low SNR

b. Power boosting of the faded carriers on the account of good carriers (done on a user basis).

The receiver in the SU can learn the channel characteristics from the pilots, thus knowing which carriers were boosted, this enabling it to reconstruct the information precisely.

Doing the procedure above for several SU simultaneously, each with different channel behavior, will achieve more efficient power transmission, since this scheme deal with inter sub-channel adaptation, i.e. with low number of sub-carriers that are spread over the band, the transmission is optimized to any channel delay spread behavior.

The SU can perform the procedures described above when transmitting information to the BS in the uplink.

The receiver and transmitter can employ a closed-loop process, in which the receiver samples the channel and sends the information to the transmitter. The transmitter uses the channel information parameters provided by the received to employ the procedures described above when transmitting data to the receiver.

The message sent by the receiver to the transmitter may have the following format, that is to include:
a. Effective time
b. Number of Samples
c. Channel Info

When:

Effective time—effective time of sent information, should be based on common reference known to both sides (receiver and transmitter).

Number of Samples—number of elements in the following field, this value shall be a function of the access-spread time.

Channel Info—Samples of the reception channel in equal spacing.

The closed loop process is a selective process, in which the receiver decides when and according to what criteria it will send the channel measurements message.

In OFDMA PMP system which are used for mobile environments, and the uplink and downlink channels are allocated, by using an uplink and/or downlink mapping message:

a. A SU may agree on a sleeping interval with the BS, this defines a time interval in which the SU will not demodulate any downstream information.

b. If the BS has information to the SU, it may either discard the information or buffer it and will send it to the SU in its next awakening point (expiration of the next sleeping interval timer).

c. In the awakening times, the BS may assign the SU a specific allocation for synchronization purposes.

d. The SU shall return to normal operation mode in the frame following the awakening frame.

Diversity channel improvement can be achieved in a system and method using concurrent communications with more than one base station, to improve the quality of communications and/or to increase the instantaneous bandwidth with a specific user, as is deemed desirable at a given moment.

A subscriber farther away from a base station suffers from the higher propagation loss, as well as from interference from another base station.

Normally, this would deteriorate communication performance with that user.

Using a novel approach, this same disadvantage can be used to our benefit: In the downlink, the same information for a specific subscriber 11 is provided to two or more base stations such as 14, 15, that are in contact with that subscriber 11. Both these base stations transmit the information to the subscriber, thus reducing the error rate and increasing throughput. Alternately, separate parts of the information are sent to the same subscriber by two or more BS, thus increasing the channel capacity.

Moreover, the diversity can be used in the uplink as well. Thus, the new system is capable of transmitting in parallel from a SU to two different BSs by using two different sub-channels. Transmission on a sub-channel to a BS with different APC per BS.

Method for Performing Hand-Over Between BSs in OFDMA system

a. Transmitting the same information from different BSs to same SU and using same sub-channel, to achieve a diversity property that will enable transition between BSs without loosing information.

b. Transmitting the same information from different BSs to same SU and using different sub-channels, to achieve a diversity property that will enable transition between BSs without loosing information.

End of method.

Adaptive Allocation Method

In an embodiment of the proposed invention, the following adaptive allocation method is used:

1. Coordination between BS for sub-channel allocations, allocation of sub-channels to a BS (number of sub-channels) according to usage load, and traffic profile in the BS.

2. Coordination between BSs of which sub-channel to allocate to which BS. For more efficient Hand-Over procedure.

3. Data and Pilots organization into a sub-channels:

a. Taking the variable pilots and performing the allocation while shifting through time.
b. Fixed pilots are equally divided between the base-stations and are transmitted all the time.
   4. Allocating the variable pilots in frequency domain.
   5. Separation between different base-stations by using a different Pseudo Noise sequence on the pilots per each Base Station.
   6. Usage of Forward Automatic Power Control (FAPC) in the downstream direction.
   7. Downlink Adaptive modulation in OFDMA systems.
   8. Selective transmission of sub-channels and pilots in the downstream channel, and not using the whole frequency.
   9. Selective transmission of sub-carriers within a sub-channel (Downstream) for TDD systems
a. Not modulating information on carriers that has low SNR
b. Power boosting of the faded carriers on the account of good carriers—done on a user basis.
   10. Selective transmission of sub-carriers within a sub-channel (Upstream)—for TDD systems. The SU performs steps 9a and 9b when transmitting information to the BS in the uplink direction.
   11. Selective transmission of sub-carriers within a sub-channel—Downstream or Upstream for TDD or FDD systems, by using a closed loop procedure.
   12. In OFDMA PMP system which are used for mobile environments, and the uplink and downlink channels are allocated, by using an uplink and/or downlink mapping message:

a. A SU may agree on a sleeping interval with the BS, this defines a time interval in which the SU will not demodulate any downstream information.

b. If the BS has information to the SU, it may either discard the information or buffer it and will send it to the SU in its next awakening point (expiration of the next sleeping interval timer).

c. In the awakening times, the BS may assign the SU a specific allocation for synchronization purposes.

The SU may return to normal operation mode in the frame following the awakening frame.

13. Employing Mobile IP protocol over OFDMA PHY layer.

In OFDMA or OFDM systems, there might be high peak-to-average. In standard power amplifiers, the power source for linear amplifiers supplies current continuously during peaks and low signal durations, which is proportional to the peaks of the transmitted signal.

A method proposed to reduce the power to the power amplifier when the signal is low. In transmitter of OFDMA\OFDM signals (in any permutations, clusters, groups or spread sub-carriers), a detection of the envelop of the transmitted signal in advance and sending a signal to the power supply of the amplifier, which accordingly changing the working point of the transistor of the power amplifier. When the signal is high more power is used, and when the signal is low, less power is used.

Method for Reducing the Power to the Power Amplifier

The method can be used for reducing the power to the power amplifier when the signal is low:

a. In a transmitter of OFDMA\OFDM signals (in any permutations, clusters, groups or spread sub-carriers), detecting the envelope of the transmitted signal in advance

b. sending a signal indicative of the envelope to the power supply of the amplifier

c. changing the working point of the transistor of the power amplifier accordingly, in the power supply. When the signal is high more power is used, and when the signal is low, less power is used.

End of method.

The new system and method are applicable both in TDD and FDD.

It will be recognized that the foregoing is but one example of an apparatus and method within the scope of the present invention and that various modifications will occur to those skilled in the art upon reading the disclosure set forth hereinbefore.

What is claimed is:

1. A cellular wireless system using a single frequency OFDMA channel, wherein base stations include means for synchronization in frequency and time for control purposes.

2. The wireless system according to claim 1, wherein the synchronization means include same Frame numbers and slot index and same reference clock.

3. The wireless system according to claim 2, wherein the same reference clock comprises GPS or another external common signal.

4. The wireless system according to claim 1, wherein the OFDM sub-channels are shared between different base stations (BSs).

5. The wireless system according to claim 1, further including a large FFT to create a large enough Guard Interval (GI) for receiving concurrent information from several BSs while using a common RF receiver and a common FFT for all the BSs.

6. The wireless system according to claim 5, wherein the FFT has a duration of at least 4 times the cell radius electromagnetic propagation time.

7. The wireless system according to claim 5, wherein the sub-channels are used in a mobile system for:
a. Performing Hand-Over between BSs;
b. Transmitting the same information from different BSs to same SU and using same sub-channel, to achieve a diversity property that will enable transition between BSs without loosing information;
c. Transmitting the same information from different BSs to same SU and using different sub-channels, to achieve a diversity property that will enable transition between BSs without loosing information.

8. The wireless system according to claim 1, further including means for transmitting in parallel from one subscriber unit (SU) to two different BSs by using two different sub-channels, with transmission on a sub-channel to a BS with different APC per BS.

9. The wireless system according to claim 1, further including means for coordination between BSs for sub-channel allocations, allocation of sub-channels to a BS (number of sub-channels) according to usage load, and traffic profile in the BS.

10. The wireless system according to claim 9, further including means for coordination between BSs on which sub-channel to allocate to which BS, for achieving a more efficient Hand-Over and/or to reduce interference.

11. In a cellular wireless system using a single frequency OFDMA channel, wherein base stations include means for synchronization in frequency and time for control purposes, a method for organizing data and pilots into sub-channels comprising pilots allocations among BSs.

12. The method according to claim 11, further including taking the variable pilots and performing the allocation while shifting through time.

13. The method according to claim 11, wherein fixed pilots are equally spread between the base-stations and are transmitted all the time.

14. The method according to claim 11, further including allocating the variable pilots in the frequency domain.

15. The method according to claim 11, further including separating between different base-stations by using a different Pseudo Noise sequence on the pilots for each Base Station.

16. The method according to claim 11, further including usage of Forward Automatic Power Control (FAPC) in the downstream direction.

17. The method according to claim 11, further including downlink adaptive modulation in OFDMA systems.

18. The method according to claim 11, further including selective transmission of sub-channels and pilots in the downstream channel, and not using the whole frequency.

19. The method according to claim 11, further using a selective transmission of sub-carriers within a sub-channel (Downstream) for TDD systems.

20. The method according to claim 19, wherein the selective transmission comprises:
a. Not modulating information on carriers that has low SNR;
b. Power boosting of the faded carriers on the account of good carriers, done on a user basis.
